(19) United States
(12) Patent Application Publication
(10) Pub. No.: US 2005/0038689 A1
(43) Pub. Date: Feb. 17, 2005

(54) Method and system for scheduling employees, allowing schedules to be checked for common errors and allowing employees to check and modify their schedule

(76) Inventor: Troy A. Shahoumian, Sunnyvale, CA (US)

Correspondence Address: Troy A. Shahoumian, PMB 407, 1030 E. El Camino, Sunnyvale, CA, 94087, US

(21) Appl. No.: 10/641,824

(22) Filed: Aug. 16, 2003

(51) Int. Cl. G06F 17/60

(52) U.S. Cl. 705/9

(57) ABSTRACT

A computer system for allowing employees to be scheduled is described. The system is accessed through a website in the preferred embodiment. Information on the various employees is stored in the system. Employees can log-in to the system to check their schedules and sign-up work unassigned work times. The system also has the notion of a routine, which is a set of requirements on a work time. For example, only a subset of the employees may be qualified to perform the routine; the routine must be started between certain times during the day; the routine must be performed during a work shift whose length falls within a given range. Routines can be specified as needed to be done on certain days of the week and the system can verify that the needed work times are accordingly scheduled.

### BACKGROUND OF INVENTION

1. Field of Invention

This invention relates to the scheduling of employees, and informing employees of these schedules.

2. Objects and Advantages

The objects and advantages of the present invention are as follows:
(a) to have an employee scheduling system accessible system through web-browser or similar thin-client.
(b) to allow scheduling data to be stored in a central location where it can be easily backed-up.
(c) to keep an employee list in the central data repository.

(d) to keep a list of tasks—also called routines, in keeping with the terminology used in home healthcare—in the central data repository.
(e) to keep information about each task in the central data repository, including
   a. What days of each week the task is to be performed on.
   b. The earliest and latest time of the day at which the task may be initiated.
   c. The minimum and maximum time to be allocated to the task.
   d. The employees qualified to perform the task.
(f) to allow the schedule to be checked for following rules such as
   a. Employees are assigned to each task which needs to be done on a given day.
   b. Schedules are checked to see that employees do not work too many or too few hours.
(g) to allow a task required to be performed on one day may actually be performed on another day if the specification of the task permits this.
(h) to allow employees to log-in to the scheduling system to check their schedules.
(i) to allow employees to log-in to the scheduling system to sign up for open work slots.
(j) to allow email to be sent to employees when their work assignment has been altered.

### BACKGROUND OF THE INVENTION

Much study and innovation has gone into employee scheduling. This activity is at the heart of almost every business imaginable. Coming up with schedules which meet business and regulatory requirements can be challenging at best. If the schedules meets employee preferences—all the better.

There is a class of scheduling needs which still is dome with paper and pencil—figuratively if not literally. These fall into the category of small business. Moreover, some scheduling needs fall outside business all together. Home-based employers have to deal with scheduling problems for babysitters, gardeners, home healthcare workers and other household help. This invention is a web-based solution—in the preferred embodiment—to meet these needs.

O'Brien in U.S. Pat. No. 6,587,831 (2003) looks at a much more complex scheduling problem. The solution is much too complex for the current need being addressed. This solution does not incorporate the flexibility and schedule-checking features of the current invention.

### SUMMARY

The current invention is for a employee scheduling system. It would be accessed by managers and employees through a web-browser. It allows employees to be scheduled and the schedules to be checked against a set of rules. Employees can log-in and check the schedules and sign up for open shifts.

### FIGURES

FIG. 1 shows the various software components of the preferred embodiment and how they communicate.

FIG. 2 shows the flowchart of the software component for deciding whether an appointment meets the requirements of a routine.

### DETAILED DESCRIPTION—PREFERRED EMBODIMENT

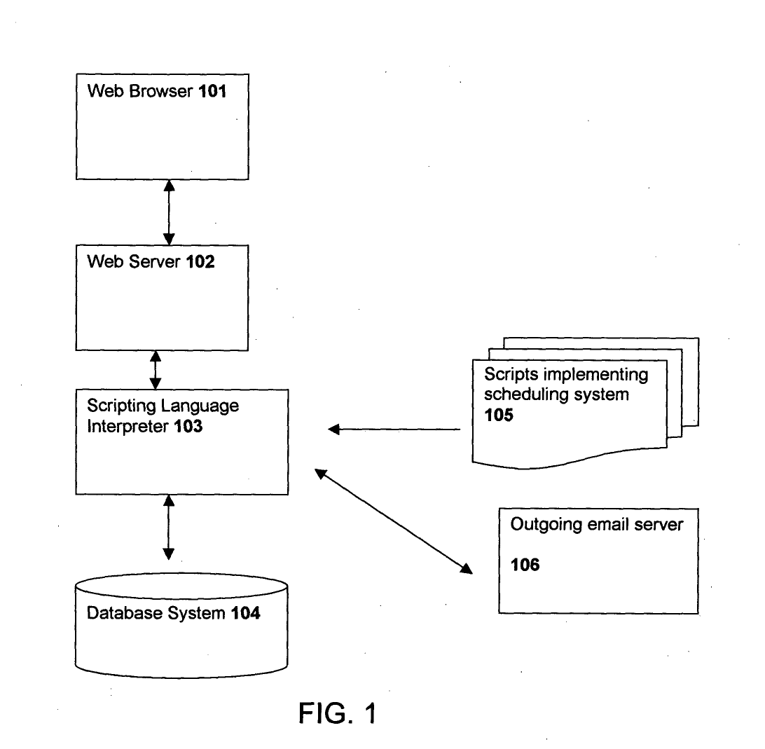

FIG. 1 describes the software components comprising the preferred embodiment of this invention. The scheduling system is accessed through a web browser 101. The web server 102 sends information to the user and receives input back from them. Dynamic pages are generated using a scripting language 103 which is running scripts 105 that implement the scheduling system. The scripting language consults a database 104 where information of appointments are stored. In the preferred embodiment the script language interpreter communicates with an external email server 106. This allows, for example, email notices to be sent to employees regarding their upcoming work hours.

One advantage of having a scheduling system managed by a third party is that it makes such a system available to someone without access to an Information Technology (IT) team. For instance, it would be available to someone scheduling a babysitters for their children, or home healthcare workers who come in to help an elderly person with daily activities. We will use the latter example throughout although it will be apparent to anyone skilled in the art that the scope of the present invention is not limited to either of these applications.

An employer starts use of the system by establishing an account and paying for use of the system for some amount of time. Information on the employers who are eligible to use the system is stored in a database table.

TABLE 1
Column names in database table storing employer information

Employer name
Employer address
Employer telephone number
Employer's email address
Employers password—after MD5 hash
Employer has access until—date

The employer's address and telephone number are stored for the employee's to access. When the employees log-in they can access this information if they have lost it.

In the preferred implementation the system does not store the employer's password. Instead, an MD5 hash of the password is stored. An explanation and specification of the MD5 has is given in Section 9.4 of Handbook of Applied Cryptography by A. J. Menezes, P. C. van Oorschot and S. A. Vanstone, CSC Press, Boca Raton 1997 and is incorporated herein by reference. When an employer attempts to log-in, we compute the MD5 hash of the password sent to the hash result stored in the database. Access is granted only if there is a match. If the employer forgets the password, a new password is generated in the preferred implementation. The new password is sent to the employer by email and the MD5 hash of the new password is stored in the database. The password of employees is stored similarly. This method of password storage and dealing with lost passwords is well-known and is not claimed as new in this invention.

After an employer signs up to use the system they then enter a list of employees into the system. The list of employees is stored in a database table with the following columns.

TABLE 2
Column names in database table storing employee information.

Employer identifier
Employee Name
Employee Identifier
Minimum desired hours per time period
Maximum desired hours per time period
Maximum numbers of self-schedulable
hours per time period

The identifier of the employer and employee is an email address in the preferred embodiment. The employee's name is optional. The employer's and employee's identifiers need not be their email address. The employer's email address is stored in the system so that they can receive information about the service, to facilitate lost password recovery, and so forth. The employee's email address should be stored in the system if the employee is to be allowed to log-in to the system, if the employee is to receive e-mail notices regarding changes in their schedule. In the preferred embodiment, employee's are required to have an email address. This invention can be implemented without the need for employee's to have an email address.

The minimum and maximum hours an employee desires to work is also optional. As can be appreciated, the time period can be of different lengths without changing the nature of this invention. For example, it could be one week, two weeks or a month.

Employees are able to log-in to the system and check their schedules. They are also able to schedule themselves for work shifts that have not been assigned to other employees. In such situations, one would not want an employee to hog all available hours. Thus, in the employee information table we record the maximum number of hours the employee can schedule themselves for. For example, if this limit is 20 hours per week, and the employee has been schedules for 15 hours, the employee can only sign themselves up for another 5 hours that week. It is of no import whether the original 15 hours were schedules by the employer or employee; either way, the employee can only schedule themselves for an additional 5 hours. The employer, on the other hand, is free to schedule the employee for however many hours desired.

After entering at least one employee in the system, the employer has the ability to add appointments. By appointment, we mean any time an employee is scheduled to work. We use this terminology in keeping with our example of scheduling home healthcare workers. Other terms such as “shift” or “work time” could also be used.

TABLE 3
Column names in database table storing appointments -
“Appointments” table

Employer identifier
Employee identifier
Start time and date
End time and date
Notes
Routine performed
Appointment unique identifier
Employer notified of appointment

The employee's identifier could be blank, or contain some other distinguished string, indicating that this appointment needs to be assigned to an employee.

The notes field is optional but is present in the preferred implementation to give employer and employee additional information about this appointment. An exemplary Notes field would be, “Employee will be painting Fido's doghouse and should wear old clothing.”

The unique identifier consists of a MD5 hash of the string consisting of the employer's identifier, the employee's identifier and the start time and date. Other ways of generating the unique identifier, including other hash functions will be apparent to those skilled in the art, and having a unique identifier for each appointment is not a crucial element of this invention.

Stored in this table is whether or not the employee has been notified of this appointment. Notification takes place by e-mail In the preferred embodiment.

Below is a discussion of routines where the role of the Routine column in the Appointments table is explained.

As can be appreciated, it is important for the system to store information on recurring appointments. There is an additional Recurrences table in the system database to hold information on recurring appointments.

TABLE 4
Columns names in database table storing
information of recurring appointments - “Recurring” table

Unique identifier of first appointment in recurrence
Date recurring appointments end
Days of week recurrence occurs

For example, an employee could be scheduled every Wednesday for the three months of January, February and March 2003 from 7 to 9 at night. We show how this information is stored in the database. Values for columns not specified are not relevant, and their role will be clear to one skilled in the art.

There will be one entry in the “Appointments” table corresponding to the first appointment in this recurrence—in this case, on Wednesday Jan. 1, 2003 from 7 p.m. to 9 p.m. This is called the base appointment.

| | |
|---|---|
| Employer identifier: | troy@example.com |
| Employee identifier: | annemarie@example.com |
| Start time and date: | Jan. 1, 2003 19:00 |
| End time and date: | Jan. 1, 2003 21:00 |
| Unique Identifier: | 33beb8e3cac47e6081043931de7ed4c1 |

To be clear, there is one entry in the Appointments table and this gives the start and end times of the base appointment. There is also one entry in the Recurrences table to describe how this appointments repeats—what days of the week and until what ending date. The row in the “Recurrences” take would be as follows.

| | |
|---|---|
| Unique identifier: | 33beb8e3cac47e6081043931ce7ed4c1 |
| Date recurring appointments | Mar. 31, 2003 |
| end: | |
| Days of week recurrence occurs: | Monday Wednesday |
| | Friday |

The unique identifier in the “Recurrences” table is the same as the base appointment's unique identifier. This allows the database to correlate the two rows with one another. In this example, Monday is the last day of March, and the last appointment in the sequence is on Mar. 31, 2003 from 7 p.m. to 9 p.m.

This is an exemplary demonstration of how recurring appointments can be stored in the database and it will be clear to one skilled in the art how the database can store other recurring appointments.

In scheduling applications, there is a need to schedule tasks to be done on certain days. We call these recurring tasks Routines, in keeping with our exemplar theme of scheduling home healthcare workers. Two illustrative routines are described below.

Exemplar Routine #1

| | |
|---|---|
| Name: | Bed |
| Notes: | Give client shower and put into |
| | bed |
| Earliest start time: | 21:00 |
| Latest start time: | 23:30 |
| Minimum hours required: | 1.0 |
| Maximum hours required: | 1.75 |
| Qualified employees: | Anne Marie, Deanna |
| Days: | Monday, Tuesday, Wednesday, Thursday, |
| | Friday, Saturday, Sunday |

Exemplar Routine #2

| | |
|---|---|
| Name: | Cleaning and laundry |
| Notes: | Clean kitchen, bathroom. Do |
| | laundry |
| Earliest start time: | 8:00 |
| Latest start time: | 13:00 |
| Minimum hours required: | 3.0 |
| Maximum hours required: | 4.0 |
| Qualified employees: | Anne Marie, Tanya |
| Days required: | Saturday |

Routines differ from recurring appointments because they do not have to start and end at the same time, nor do they have to be performed by the same person each time.

The ability to specify such routines and then see which routines are covered by the schedule is an advantage of the system.

Information on the routines is stored in a “Routines” table. Specification of which employees are qualified for which routines is stored in the “Qualified Employee” table.

TABLE 5
Columns names in database table storing information
about routines - “Routines” table

Routine name
Days required
Earliest start time
Latest start time
Minimum hours
Maximum hours

TABLE 6
Columns names in database table storing information
about which employees are qualified for which routines - “Qualified
Employee” table

Employer identifier
Employee identifier
Routine name

In the “Routines” table, the Days required column lists the days of the week on which this routine must be scheduled. The columns Earliest start times and Latest start times give a window in which any appointment fulfilling the requirements of this routine must fall. The columns Minimum hours/Maximum hours determine the required length of an appointment satisfying the routine.

Another key part of this invention is that the earliest/latest starting times specified by a routine do not need to fall in the range 00:00 to 23:59. This corresponds to the fact that, even though a routine is required to be done on a certain day of the week, it may be performed before the day begins or after the day ends. We give two exemplar situations where this might be useful in scheduling home healthcare workers.

Consider the routine cited above for putting someone into bed. If we make the minimum/maximum start times 21:00 and 26:00 respectively, this means that the routine for Friday could be scheduled as late as Saturday at 2:00 a.m. Thus, an appointment satisfying that this routine occur on Friday might not start until Saturday has officially begun.

Consider another routine for taking the trash out to the curb. Assuming trash day is Tuesday and the range of start times is—3:00 to 6:00, an appointment satisfying this routine can start as early as Monday at 9:00 p.m.—three hours before midnight—and as late as Tuesday at 6:00 a.m.

The allowed start and end times for a routine can fall out of the range 00:00 to 23:59. Negative values denote times before the day has begun. Times greater than 23:59 denote times after the day has ended.

To this point, it has been assumed that routines are scheduled on a one-week horizon. In other words, it was assumed that routines are required to be performed on the same days each week. This invention is not limited to one week time horizons for specifying the days on which a routine is required.

To give an exemplar situation where two week scheduling would be used, suppose a pampered dog is to be given a bath every other day without fail. One week, the dog is bathed Monday, Wednesday, Friday and Sunday. The following week, the dog is bathed on Tuesday, Thursday and Saturday. The cycle begins anew the third week.

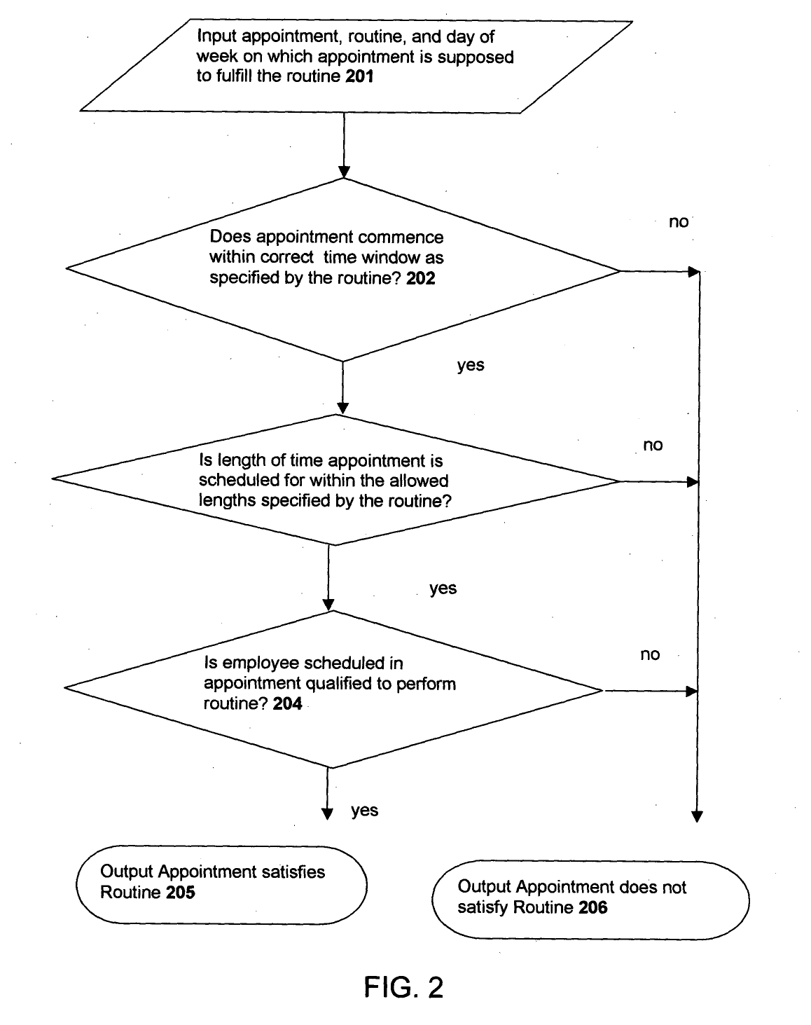

The method for determining whether an appointment meets the requirements of a routine is diagramed in FIG. 2. The input 201 to the routine includes the appointment, the routine definition, and the day on which we want to know whether the appointment satisfies the routine. In light of the above discussion, the day we are testing for satisfaction may differ from the day on which the appointment begins. The first test performed 202 is to decode whether the appointment begins in the correct time window. The second test 203 is to decide if the length of the appointment is in the range dictated by the routine. The third test 204 determines whether the employee scheduled is qualified to perform the routine. If all test pass the algorithm outputs 205 that the appointment meets the requirements of the appointment for the day specified. If any test fails, the algorithm outputs 206 that the appointment does not meet the requirements.

The main advantages of this system are as follows.
(a) Web-based scheduling system with no maintenance needed by users.
(b) System can be used by multiple employers, making the cost to each employer modest.
(c) Employees can log-in to the system to check their schedules and sign-up for open slots.
(d) Rules for verifying a schedule meets some basic rules which are easy to understand.

The scope of this invention should be determined by the appended claims and their legal equivalents, rather than by the examples given.

1. A computer system for providing a scheduling service which permits a plurality of managers to schedule a plurality of employees for a plurality of work times, comprising:
(a) an information repository for storing information about
i) information for authenticating said managers when they access said scheduling service,
ii) a list of said employees which can be scheduled, and
(b) an interface to said scheduling system which allows said managers to accomplish the tasks of
i) scheduling said employees for said work times, and
ii) displaying said work times recorded in said information repository.

2. The computer system of claim 1 wherein said scheduling service is accessed through a computer network by a web browser.

3. The computer system of claim 1 wherein said scheduling system is maintained by service provider for said managers employed by a plurality of entities.

4. The computer system of claim 1 wherein said scheduling system is maintained by service provider that backs-up said information repository.

5. The computer system of claim 1 wherein said scheduling service is accessed by said employees and said scheduling system provides means for informing said employee of their said work times.

6. The computer system of claim 1 wherein said scheduling service is accessed by said employees and said scheduling system provides means for said employees to schedule themselves for said work times not yet assigned to one of said employees

7. The computer system of claim 1 wherein said scheduling system provides means for the storage of routine requirements for a plurality of routines in said information repository.

8. The routine requirements of claim 7 include the minimum and maximum time-slot to be allocated for performing routine.

9. The routine requirements of claim 7 include the earliest time during the day in which the time-slot for performing said routine on said day may commence.

10. The earliest time of claim 9 is allowed to be before said day begins.

11. The routine requirements of claim 7 include a specification of the days of a plurality of consecutive weeks on which one work time must be scheduled which meets the requirements of said routine.

12. The routine requirements of claim 7 include the latest time during the day in which the time-slot for performing said routine on said day may commence.

13. The latest time of claim 12 is allowed to be after said day ends.

14. The routine requirements of claim 7 include a designation of a subset of said employees qualified to perform said routine.

15. The computer system of claim 1 wherein said scheduling system is further comprised of a work time verification component which determines whether said work time meets the requirements of a routine.

16. The computer system of claim 1 wherein said scheduling system is further comprised of a schedule verification component which determines whether said work times scheduled during a given time period meet the requirements for the routines required to be scheduled during said time period.

17. A method of constructing a computer system for providing a scheduling service which permits a plurality of managers to schedule a plurality of employees for a plurality of work times, comprising:
(a) an information repository for storing information about
i) information for authenticating said managers when they access said scheduling service,
ii) a list of said employees which can be scheduled, and
(b) an interface to said scheduling system which allows said managers to accomplish the tasks of
i) scheduling said employees for said work times, and
ii) displaying said work times recorded in said information repository.
